(19) United States
(12) Patent Application Publication
(10) Pub. No.: US 2017/0029302 A1
(43) Pub. Date: Feb. 2, 2017

(54) FACILITY FOR TREATMENT OF AN AQUEOUS EFFLUENT BY HYDROTHERMAL OXIDATION

(71) Applicant: Innoveox, Paris (FR)

(72) Inventors: Grégoire Sarrail, Paris (FR); Olivier Sadoschenko, Paris (FR)

(73) Assignee: Innoveox, Paris (FR)

(21) Appl. No.: 15/113,333

(22) PCT Filed: Jan. 21, 2015
(86) PCT No.: PCT/EP2015/051173

§ 371 Date: Oct. 20, 2016

(30) Foreign Application Priority Data
Jan. 21, 2014 (FR) 1450476

(51) Int. Cl. C02F 1/72; B01F 3/04; B01J 19/24; B01F 5/06; B01F 15/02; B01J 4/00; C02F 1/02; B01F 5/04

(52) U.S. Cl. CPC C02F 1/727; C02F 1/025; B01F 3/04503; B01F 5/0461; B01F 5/0647; B01F 15/0201; B01J 4/001; B01J 19/243; B01F 2003/04879; B01F 2015/0221; B01F 2215/0052

(57) ABSTRACT

The invention relates to a facility for treatment of an aqueous effluent by hydrothermal oxidation, which comprises: a reactor comprising a tube in which the aqueous effluent to be treated flows, the tube of the reactor having a plurality of bends formed by oxidant-injection devices, each oxidant-injection device comprising: a reactor part (32) forming an effluent-circulation channel (35) bent at an angle in which a flow of aqueous effluent can circulate, and an injector part (33) comprising a first opening (49) suitable for being connected to a source of oxidant located outside the effluent-circulation channel (35) and a second opening (50) located in the effluent-circulation channel (35), and a source of oxidant connected to the injector part so as to inject the pressurised oxidant into the flow of aqueous effluent to be treated.

### FIELD OF THE INVENTION

The invention relates to a device for injecting oxidant for a facility for treating an aqueous effluent by hydrothermal oxidation, and an associated treatment facility.

### PRIOR ART

Multiple methods for treating aqueous effluents comprising organic waste and/or dissolved salts have been described, among which can be cited in particular those wherein the effluent to be treated is placed in the presence of an oxidizing agent under socalled “hydrothermal” conditions, which lead to oxidation of the waste. In particular, it is known to treat aqueous effluents at a temperature and a pressure wherein the water is in a subcritical or supercritical state (the critical point of water being situated at a temperature of 374 degrees Celsius and a pressure of 221 bars).

In the case of organic compounds, the treatment leads typically to oxidation in the form of simple compounds such as CO₂ and H₂O. Metal salts other than the alkali and alkali earths are, for their part, typically converted into metal hydroxides.

A method of this type, which has proven particularly interesting, which makes it possible to control the elevation of temperature caused during hydrothermal oxidation, is described in document WO 02/20414. In the method described in this document, the effluent is treated within a tubular reactor by introducing the oxidizing agent, not just all at once, but progressively along the tubular reactor, at several points along the path of the effluent, which makes it possible to progressively increase the temperature of the flow along a rising curve, from an initial subcritical temperature (for example on the order of ambient or higher) up to a supercritical temperature. In this manner, the oxidation of the organic compounds contained in the effluent is carried out progressively during its flow and the thermal energy produced during the oxidation reaction at each injection is used to cause the reactive mixture to pass progressively from a subcritical state in the liquid phase to a supercritical state.

The oxidation reaction produces a large quantity of thermal energy in the zones where the oxidant concentration is highest, that is in the oxidant injection zones. The occurrence of these hot zones is capable of damaging the walls of the reactor. It is therefore desirable to control this release of thermal energy.

Moreover, document U.S. Pat. No. 5,582,715 describes a facility for treating an aqueous effluent by hydrothermal oxidation comprising a tubular reactor forming a circular coil and having a plurality of injection side ports, and oxidant injection nozzles extending through the ports and allowing oxidant to be injected into the center of the flow,

In practice, however, such injection nozzles cannot be obtained by machining and their manufacture is complex.

### SUMMARY OF THE INVENTION

One objective of the invention is to propose a facility which allows injection of oxidant into the heart of the flow and which comprises oxidant injection devices that are easier to manufacture or to assemble.

This objective is attained within the scope of the present invention thanks to a facility for treating an aqueous effluent by hydrothermal oxidation, comprising:
a reactor comprising a tube in which the aqueous effluent to be treated circulates, the tube of the reactor having several bends formed by oxidant injection devices, each oxidant injection device comprising:
   a reactor part forming an effluent circulation channel with a bent shape in which an aqueous effluent flow can circulate, the effluent circulation channel having a first channel portion through which the effluent flow enters into the reactor part and in which the effluent flow circulates in a first circulation direction, and a second channel portion in which the effluent flow circulates in a second circulation direction forming a non-zero angle with the first circulation direction, and leaves the reactor part, and
   an injector part comprising a first opening suitable for being connected to an oxidant source located outside the effluent circulation channel, a second opening located in the second channel portion, and an oxidant injection channel extending from the first opening until the second opening in a direction parallel to the second circulation direction, so as to inject the oxidant in the effluent flow when the effluent is circulating in the second channel portion, and
an oxidant source connected to the injector part to inject the oxidant under pressure inside the aqueous effluent flow to be treated.

In such a facility, the effluent circulation channel is provided with a bend, which makes it possible to contemplate a device wherein the first channel portion and the second channel portion are obtained by machining.

Moreover, the invention takes advantage of the bend of the effluent circulation channel to provide a straight (or rectilinear) injection tube which can also be obtained by machining.

The facility can further have the following features:
the injector part comprises an injection tube extending inside the effluent circulation channel over a distance greater than a diameter of the effluent circulation channel,
the injection tube extends inside the effluent circulation channel over a distance greater than twice the diameter of the effluent circulation channel,
the injection channel extends coaxially with the second channel portion,
the reactor part has a longitudinal bore forming the second channel portion and a side bore forming the first channel portion, the side bore leading into the longitudinal bore while forming a bend,
the reactor part comprises a third bore extending coaxially with the longitudinal bore, the injector part entering the second channel portion through the third bore,
the injector part is welded to the reactor part,
the injector part comprises a helical groove formed on an outer surface of the injector part in contact with the effluent flow to put into rotation the effluent flow circulating in the second channel portion around an axis of rotation parallel to the second flow direction,
the tube is coiled to form several turns, each turn having a bend formed by an oxidant injection device, the bends being superimposed one on the other so that the injection devices are grouped in the same zone of the coil.

### PRESENTATION OF THE DRAWINGS

Other features and advantages will be further highlighted by the description that follows, which is purely illustrative and not limiting, and must be read with reference to the appended figures, among which:

FIG. 1 shows schematically a treatment facility conforming to one embodiment of the invention,

FIG. 2 shows schematically a reactor incorporated in the treatment facility,

FIG. 3 is a section view of an oxidant injection device conforming to a first embodiment of the invention,

FIG. 4 is a section view of an injection device conforming to a second embodiment of the invention,

FIG. 5 is a perspective view of an injector part incorporated into the device of FIG. 4.

### DETAILED DESCRIPTION OF ONE EMBODIMENT

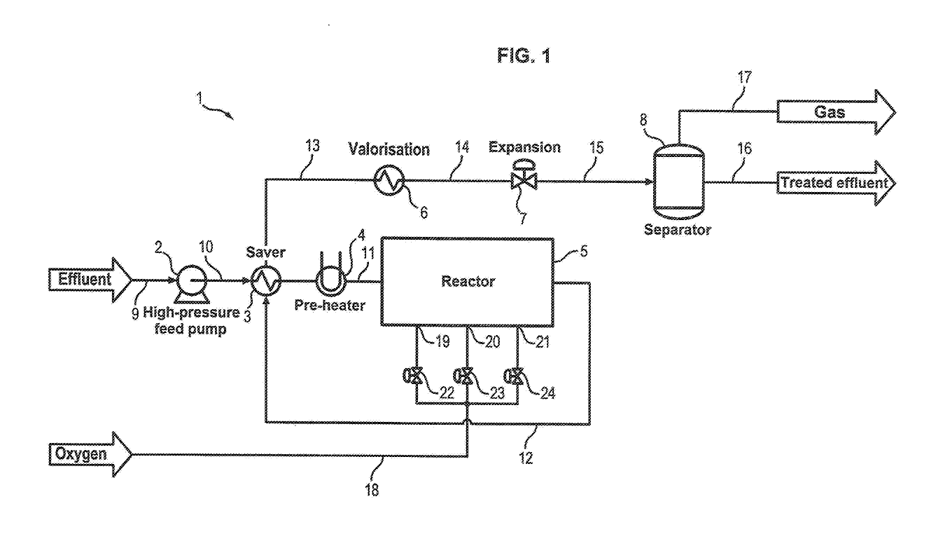

In FIG. 1, the treatment facility 1 shown comprises a high-pressure feed pump 2, a heat exchanger 3, a pre-heater 4, a reactor 5, a cooler 6, an expansion valve 7 and a separator 8.

The feed pump 2 receives as its input an effluent flow to be treated 9 and injects the flow under pressure 10 into the heat exchanger 3. The feed pump 2 raises the effluent flow to be treated 9 from atmospheric pressure to a pressure greater than 221 bars for example, in the case of treatment under supercritical conditions.

The effluent flow under pressure 10 is transported into the heat exchanger 3, where it is heated. The effluent flow under pressure 10 is heated by heat exchange with a flow of treated effluent 12 collected at the output of the reactor 5. The heat exchanger 3 thus makes it possible to heat the effluent to be treated 10 to a temperature comprised between 100 and 350 degrees Celsius for example, before the effluent flow to be treated is introduced into the reactor 5.

The effluent flow to be treated 10 is also transported into the pre-heater 4. The pre-heater 4 makes it possible to heat the effluent flow to be treated 10 prior to introducing it into the reactor 5. The pre-heater is activated only during a transitional phase when starting the treatment process. Indeed, during the starting phase, the heat exchanger 3 does not allow sufficient pre-heating of the effluent to be treated 10. Once the facility is operating in a steady state, the pre-heater 4 is no longer necessary and can be deactivated. The heat exchanger 3 is sufficient for obtaining adequate heating of the effluent to be treated 10.

Once heated, the effluent flow to be treated 11 is introduced into the reactor 5 to be treated. The reactor 5 receives as its input, on the one hand the effluent flow to be treated 11 and, on the other hand, a flow of oxygen under pressure 18 needed for the oxidation reaction. More precisely, the effluent flow to be treated 11 circulates in the reactor 5 and oxygen is injected inside the reactor, at different injection points 19, 20, 21 along the path of the effluent flow 11,

The different injection points 19, 20, 21 are connected to a pressurized oxygen feed circuit.

The facility 1 also comprises a set of valves 22, 23, 24 to adjust the quantity of oxygen injected at each injection point.

The treated effluent 12 is collected at the output of the reactor 5 and is injected into the heat exchanger 3 to heat the effluent flow to be treated 10 entering the reactor 5. In the steady state, the effluent flow 12 leaving the reactor has a temperature comprised between 500 and 600 degrees Celsius for example.

After having circulated in the heat exchanger 3, the treated effluent flow 13 is sent to the cooler 6 where it is cooled down to a temperature less than 100 degrees Celsius. The cooler 6 makes it possible to recover the thermal energy of the effluent produced by using it for example for producing thermal or electric energy.

Once cooled, the effluent 14 leaving the cooler 6 undergoes expansion due to the expansion valve 7. The cooled effluent 15 is then under atmospheric pressure, The effluent 15 takes the form of a mixture of gases, comprising in particular carbon dioxide (CO₂), as well as possibly nitrogen (N₂) and oxygen (O₂), and liquid, the liquid consisting essentially of water no longer containing organic matter.

The mixture at the output of the expansion valve 7 is injected into the separator 8 so as to separate the gaseous phase 17 from the liquid phase 16.

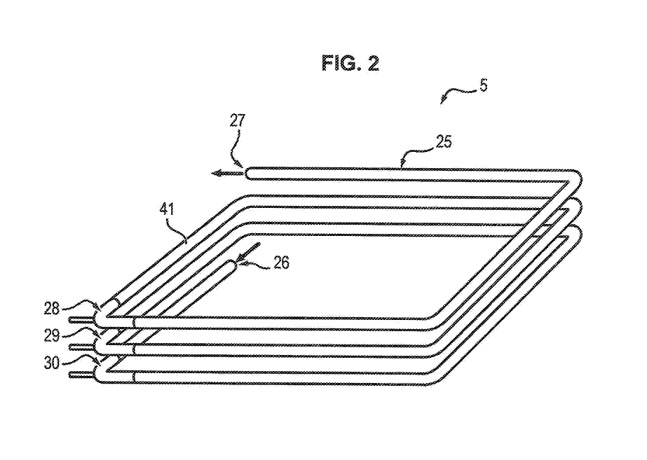

FIG. 2 shows schematically the reactor 5 incorporated into the treatment facility 1.

The reactor 5 comprises a tube 25 of generally elongated shape, having an input 26 and an output 27, wherein circulates the effluent flow to be treated. The tube 25 for circulating the effluent to be treated is a cylinder of revolution and is for example formed from an alloy of nickel and chromium.

The tube 25 for circulating the effluent is folded over itself forming several loops (or turns). Here each loop has a generally rectangular shape. More precisely, each loop contains straight segments interconnected by bends.

In FIG. 2, the tube 25 comprises three oxygen injection devices 28 to 30 each forming a bend of the tube 25 for circulating effluent. The three oxygen injection devices 28 to 30 are mutually identical.

The oxygen injection devices 28 to 30 are positioned one above the other. This arrangement makes it possible to group the injection devices 28 to 30 in one same zone of the facility, which allows the connection of the three oxygen injection devices to the same pressurized oxygen feed circuit, connected in the same direction. This has the advantage of facilitating maintenance of the facility.

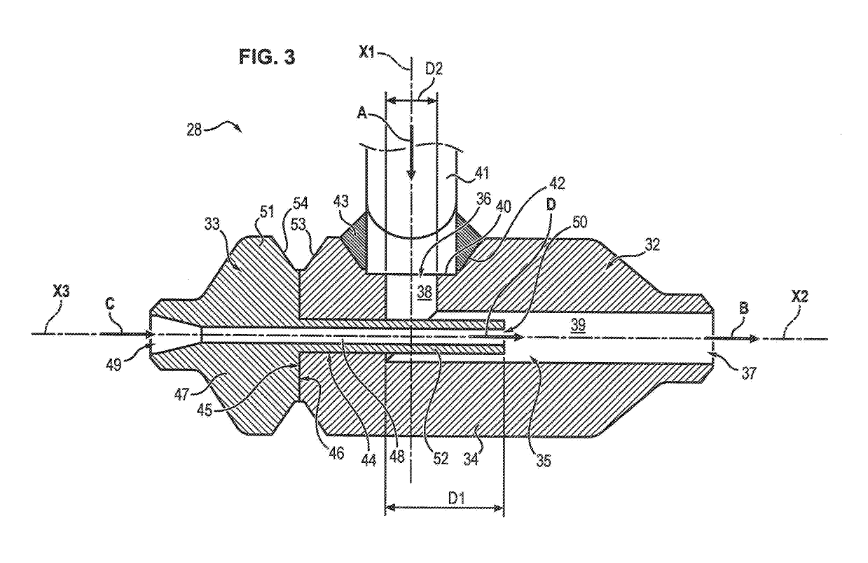

FIG. 3 shows an oxygen injection device 28 conforming to a first embodiment of the invention.

The oxygen injection device 28 comprises a reactor part 32 and an injector part 33.

The reactor part 32 comprises a body 34 formed from a single piece of material, made for example of an alloy of nickel and chromium.

The reactor part 32 comprises a channel 35 for circulating effluent formed in the body 34 and wherein the aqueous effluent flow can circulate. The effluent circulation channel 35 extends from a first opening 36 through which the effluent flow enters the reactor part (arrow A), until a second opening 37 through which the effluent flow leaves the reactor part (arrow B).

The effluent circulation channel 35 has a bent shape. More precisely, the effluent distribution channel 35 has a first channel portion 38 extending along a first direction with an axis X1 and a second channel portion 39 extending along a second direction with an axis X2, the axis X2 forming a right angle with the axis X1. The first channel portion 38 extends from the first opening 36 to the second channel portion 39. The second channel portion 39 extends from the first channel portion 38 to the second opening 37.

The first channel portion 38 has a cylinder-of-revolution shape having the axis X1 as the axis of revolution. The second channel portion 39 has a cylinder-of-revolution shape having the axis X2 as the axis of revolution. Each of the two channel portions 38 and 39 has a circular section, having identical inner diameters.

In practice, the second channel portion 39 has been obtained by a longitudinal boring along the axis X2 of the body 34 of the reactor part 32. The first channel portion 38 has been obtained by a side boring along the axis X1 of the body 34 of the reactor part 32, the side bore leading into the longitudinal bore so as to form the bend.

The reactor part 32 also has a first support surface 40 formed by a shoulder, surrounding the first opening 36, and suitable for being put in contact with one end of a straight segment 41 of the reactor tube 25 to connect the straight segment 41 to the reactor part 32.

The reactor part 32 further comprises a conical surface 42 formed by a chamfer surrounding the support surface 40. The conical surface 42 defines with an outer surface of the straight segment 41 of the tube a groove suitable for receiving a weld bead 43, so as to attach the straight segment 41 of the tube onto the reactor part 32 and obtain a sealing contact between the two parts 32 and 41.

In this manner, the first opening 36 of the reactor part 32 is connected to a first straight segment 41 of the tube while the second opening 37 is connected to a second straight segment of the tube (not shown), the second straight segment of the tube forming a right angle with the first straight segment of the tube.

Moreover, the reactor part 32 comprises a third opening 44 for injecting oxygen into the effluent to be treated circulating in the channel 35.

The third opening 44 is obtained by boring the body 34 along the longitudinal direction of the axis X1.

In this first embodiment, the third opening 44 has a diameter smaller than the diameter of the second channel portion 39.

The reactor part 32 has a second support surface 45, surrounding the third opening 44, the second support surface 45 being suitable for being put into contact with a support surface 46 of the injector part 33 to connect the injector part 33 to the reactor part 32.

The injector part 33 comprises a body 47 formed from a single piece of material, for example an alloy of nickel and chromium, and an oxygen injection channel 48 extending through the body 47. The injector part 33 comprises a first opening 49 intended to be connected to a pressurized oxygen feed circuit and a second opening 50 through which oxygen is released into the effluent to be treated. The oxygen injection channel 48 has a rectilinear form along an axis X3. The oxygen injection channel 48 extends from the first opening 49 through which the flow of oxygen entered the injector part (arrow C), until the second opening 60 through which the flow of oxygen leaves the injector part (arrow D).

Moreover, the body 47 has a connecting portion 51 extending outside the reactor part 32 and intended to be connected to a pressurized oxygen feed circuit, and a portion extending inside the reactor part 32 forming an oxygen injection tube 52 for injecting pressurized oxygen into the effluent to be treated.

The connecting portion 51 and the oxygen injection tube 52 are formed by machining the body 47. In particular, the injection channel 48 is formed by boring through the body 47 along the axis X3.

The oxygen injection tube 62 has the shape of a cylinder of revolution having the axis X3 as its axis of revolution. The oxygen injection tube 52 is positioned through the body 34 of the reactor part 32, through the third opening 44 to the inside of the second channel portion 39, so that the axis X3 of the oxygen injection tube 52 is coincident with the second axis X2 of the second channel portion 39.

Moreover, the oxygen injection tube 52 is oriented so that a flow of oxygen is injected into the second canal portion 39 in a direction and a direction of injection (arrow D) identical to the direction and the direction of circulation of the effluent to be treated in the second channel portion (arrow B).

Moreover, the oxygen injection tube 52 extends within the effluent circulation channel 35 over a distance D1 greater than the diameter D2 of the effluent circulation channel 35, preferably twice the diameter of the effluent circulation channel 35. For example, the oxygen injection tube 52 extends inside the effluent circulation channel 35 over a distance equal to 36 millimeters.

In this manner, the oxygen injected into the effluent flow to be treated is confined to the center of the tube 25 of the reactor 5, which limits the risk of damaging the walls of the reactor 5.

The connecting portion 51 of the injector part 33 has a supporting surface 46 extending transversely to the axis X3 and suitable for being put into contact with the supporting surface 45 of the reactor part 32 to connect the injector part 33 to the reactor part 32.

Moreover, the reactor part 32 and the injector part 33 each have a conical surface 53, 54 formed by chamfering, the conical surfaces 53 and 54 being arranged so that when the two parts 32 and 33 are put into contact with one another, the conical surfaces 53 and 54 form a groove having a V cross-section, the groove allowing the formation of a weld bead to attach the two parts to one another.

In operation, a effluent flow to be treated circulates in the bent channel 35 of the reactor part 32. The effluent flow to be treated enters by the first opening 36, circulates in the first channel portion 38 in a first circulation direction (parallel to the axis X1), then circulates in the second channel portion 39 in a second circulation direction (parallel to the axis X2) and leaves the reactor part 32 by the second opening 37. Oxygen under pressure is injected through the injection tube 52 into the center of the effluent flow, while the effluent flow circulates in the second channel portion 39.

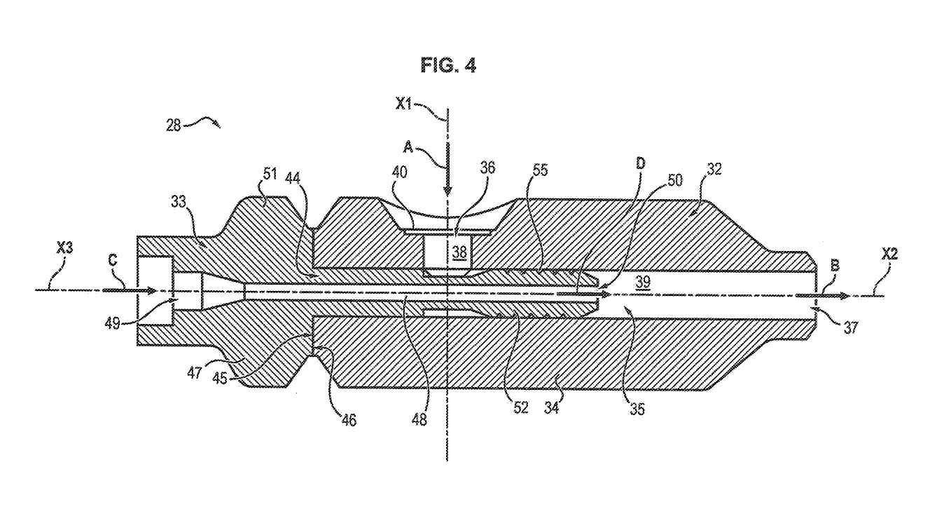

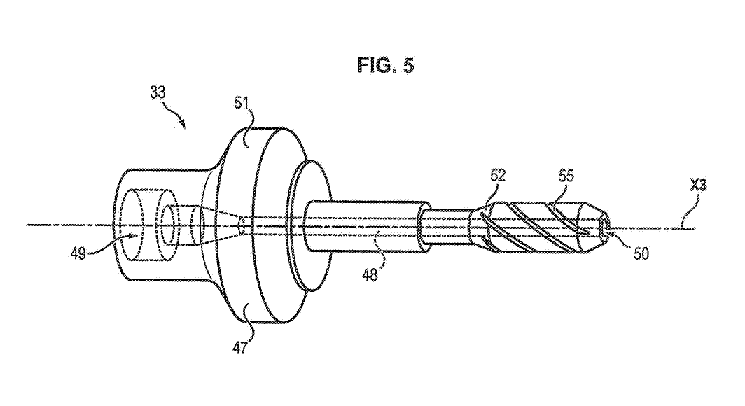

FIGS. 4 and 5 show schematically an oxygen injection device 28 conforming to a second embodiment of the invention.

The oxygen injection device 28 shown in FIGS. 4 and 5 is identical to the injection device 28 of FIG. 3, except that the oxygen injection tube 52 has a helical groove 55 provided on its outer surface.

The presence of the helical groove 55 has the effect of putting into rotation about the axis X2 the effluent flow circulating in the second channel portion 39, parallel to the second flow direction.

Putting the flow into rotation creates a vortex which contributes to confining the oxygen injected through the oxygen injection tube 52 to the center of the effluent flow.

Moreover, the oxygen injection tube 52 has a bulging portion 66 having an outer diameter identical to the inner diameter of the second channel portion 39, and the helical groove 55 is formed in the outer surface of the bulging portion 56, so that the effluent flow is forced to pass in the helical groove 55 when it circulates in the second channel portion 39.

1. A facility for treating an aqueous effluent by hydrothermal oxidation, comprising:
a reactor comprising a tube in which the aqueous effluent to be treated circulates, the tube of the reactor having several bends formed by oxidant injection devices, each oxidant injection device comprising:
a reactor part forming an effluent circulation channel with a bent shape in which an aqueous effluent flow can circulate, the effluent circulation channel having a first channel portion through which the effluent flow enters into the reactor part and in which the effluent flow circulates in a first circulation direction and a second channel portion in which the effluent flow circulates in a second circulation direction forming a nonzero angle with the first circulation direction, and leaves the reactor part, and
an injector part comprising a first opening suitable for being connected to an oxidant source located outside the effluent circulation channel, a second opening located in the second channel portion and an oxidant injection channel extending from the first opening to the second opening in a direction parallel to the second circulation direction, so as to inject the oxidant in the effluent flow when the effluent is circulating in the second channel portion, and
an oxidant source connected to the injector part to inject the oxidant under pressure inside the aqueous effluent flow to be treated.

2. The facility according to claim 1, wherein the injector part comprises an injection tube extending inside the effluent circulation channel over a distance greater than a diameter of the effluent circulation channel.

3. The facility according to claim 2, wherein the injection tube extends inside the effluent circulation channel over a distance greater than twice the diameter of the effluent circulation channel.

4. The facility according to claim 1, wherein the oxidant injection channel extends coaxially with the second channel portion.

5. The facility according to claim 1, wherein the reactor part has a longitudinal bore forming the second channel portion and a side bore forming the first channel portion, the side bore leading into the longitudinal bore while forming a bend.

6. The facility according to claim 5, wherein the reactor part comprises a third bore extending coaxially with the longitudinal bore, the injector part entering the second channel portion through the third bore.

7. The facility according to claim 1, wherein the injector part is welded to the reactor part.

8. The facility according to claim 1, wherein the injector part comprises a helical groove formed on an outer surface of the injector part, in contact with the effluent flow to put into rotation the effluent flow circulating in the second channel portion around an axis of rotation parallel to the second flow direction.

9. The facility according to claim 1, wherein the tube is coiled to form several turns, each turn having a bend formed by an oxidant injection device, the bends being superimposed one on the other so that the injection devices are grouped in the same zone of the coil.
